(19) United States
(12) Patent Application Publication
(10) Pub. No.: US 2019/0212893 A1
(43) Pub. Date: Jul. 11, 2019

(54) SYSTEM AND METHOD FOR GESTURE DOCUMENT PROCESSING

(71) Applicants: Kabushiki Kaisha Toshiba, Minato-ku (JP); Toshiba TEC Kabushiki Kaisha, Shinagawa-ku (JP)

(72) Inventor: Michael L. YEUNG, Mission Viejo, CA (US)

(21) Appl. No.: 16/299,427

(22) Filed: Mar. 12, 2019

Related U.S. Application Data
(63) Continuation of application No. 15/134,120, filed on Apr. 20, 2016.

(51) Int. Cl. G06F 3/0488; G06F 17/21; G06F 3/0484; G06F 3/0486

(52) U.S. Cl. CPC G06F 3/0488; G06F 17/211; H04L 67/1097; G06F 3/0486; G06F 3/04842

(57) ABSTRACT

A system and method for combining documents on mobile computing devices based on gestures input by users on a touchscreen includes a touchscreen that is configured to display a list of documents and accept the gestures as inputs, and a processor configured to generate the list of document displayed on the touchscreen, and interpret the gestures to combine documents from the list. Gestures include selecting a first document from the list, dragging the first document over to the second document on the list, and dropping the first document onto the second document. The touchscreen displays a view of the pages the combined document and user gesture can reorder the pages. The documents and page order are stored in a linked list that is used to generate the combined document. Suitable documents include network accessible documents, as well as local documents and picture from the mobile computing device.

### REFERENCE TO RELATED APPLICATIONS

This application is a continuation of U.S. patent application Ser. No. 15/134,120, filed Apr. 20, 2016, the entire disclosures of which are hereby each incorporated herein by reference.

### TECHNICAL FIELD

This application relates generally to using gestures on mobile computing devices to combine documents. The application relates more specifically to use of finger gestures on the touchscreen of a mobile computing device to combine and organize multiple documents into a single document.

### BACKGROUND

Multiple documents can be combined into a single document in some desktop computer applications. For example, in certain PDF editing programs two PDFs, or portable document format documents, can be joined together and then saved as a new document using options available via menu bars.

However, in the mobile environment, users of mobile devices often have documents stored on different sources, such as cloud servers, or networked storage devices in addition to documents stored locally on the mobile device. For example, a user can have one document stored on a share drive, another document accessible via DROPBOX, and a third document on BOX.COM. Other cloud based service providers provide similar capabilities. This networked storage of documents on disparate network devices presents challenges to users who desire the ability to combine multiple documents into a new document on their mobile device. A user can find it difficult or impossible to create the desired document that can then be used further down the user workflow or emailed to another person.

### SUMMARY

In accordance with an example embodiment of the subject application, a system and method combines documents based on gestures input by users on a touchscreen of a mobile computing device. The mobile computing devices includes a touchscreen configured to display a list of documents and accept the gestures as inputs, and a processor configured to generate the list of document displayed on the touchscreen, and interpret the gestures to combine documents from the list. Gestures include selecting a first document from the list, dragging the first document over to the second document on the list, and dropping the first document onto the second document. The touchscreen can display a view of the pages the combined document and additional user gestures can reorder the pages of the combined document. The documents and page order can be stored in a linked list that is used to generate the combined document. Suitable documents include network accessible documents, as well as local documents and picture from the mobile computing device.

### BRIEF DESCRIPTION OF THE DRAWINGS

Various embodiments will become better understood with regard to the following description, appended claims and accompanying drawings wherein:

FIG. 1 is a block diagram of a gesture-based document composition system for mobile computing devices;

FIG. 2A is a first example operation of a gesture-based document composition system for mobile computing devices;

FIG. 2B is a second example operation of a gesture-based document composition system for mobile computing devices;

FIG. 2C is a third example operation of a gesture-based document composition system for mobile computing devices;

FIG. 2D is a fourth example operation of a gesture-based document composition system for mobile computing devices;

FIG. 2E is a fifth example operation of a gesture-based document composition system for mobile computing devices;

FIG. 3 is an example embodiment of a mobile computing device; and

FIG. 4 is a flowchart of an example embodiment of a gesture-based document composition system for mobile computing devices.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

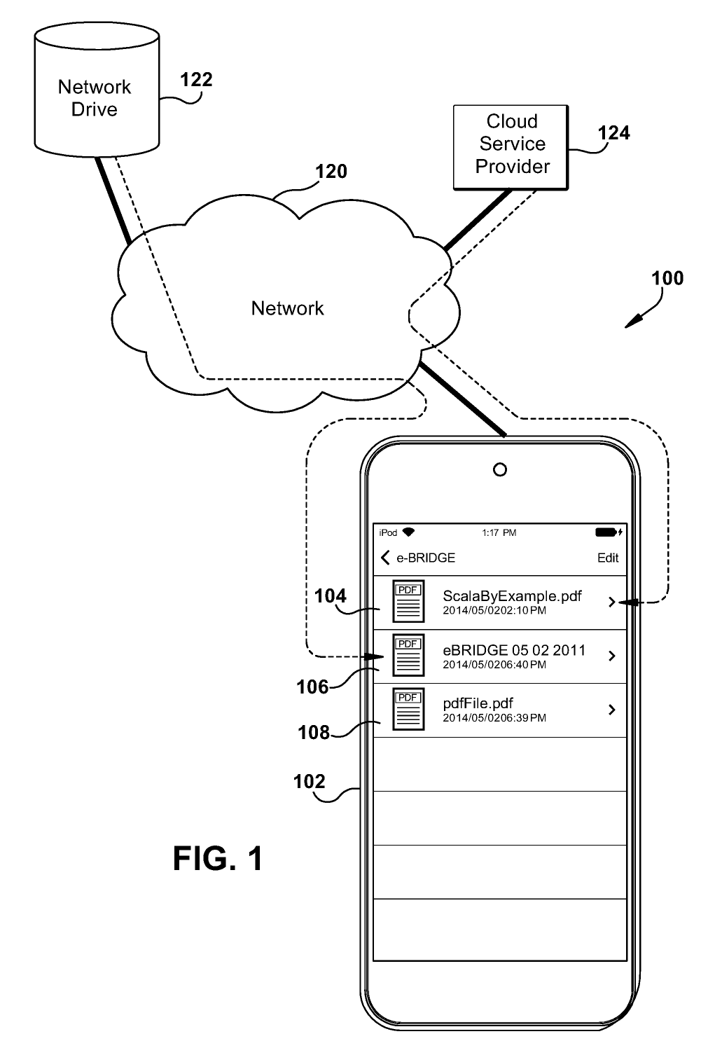

In accordance with the subject application, FIG. 1 illustrates an example embodiment of a gesture-based document composition system 100. Although described and illustrated with reference to mobile computing devices such as smart phones, tablets, and other touchscreen enabled mobile computing devices, the systems and method described herein can also be applicable to other types of computing devices, including but not limited to personal computers, laptops, workstations, and embedded computing devices among other suitable computing devices. One such embedded computing device is a multifunction peripheral (MFP) or multifunction device (MFD). MFPs and MFDs can combine printer, copier, scanner, fax, and email capabilities into a single unit. In an embodiment, the gesture-based document composition system 100 can execute in an MFP or MFD. In an embodiment, the gesture-based document composition system 100 can execute in the cloud, for example a network server, and be accessible via a web browser, dedicated application on a mobile device, or any other suitable means for communicating with cloud-based services.

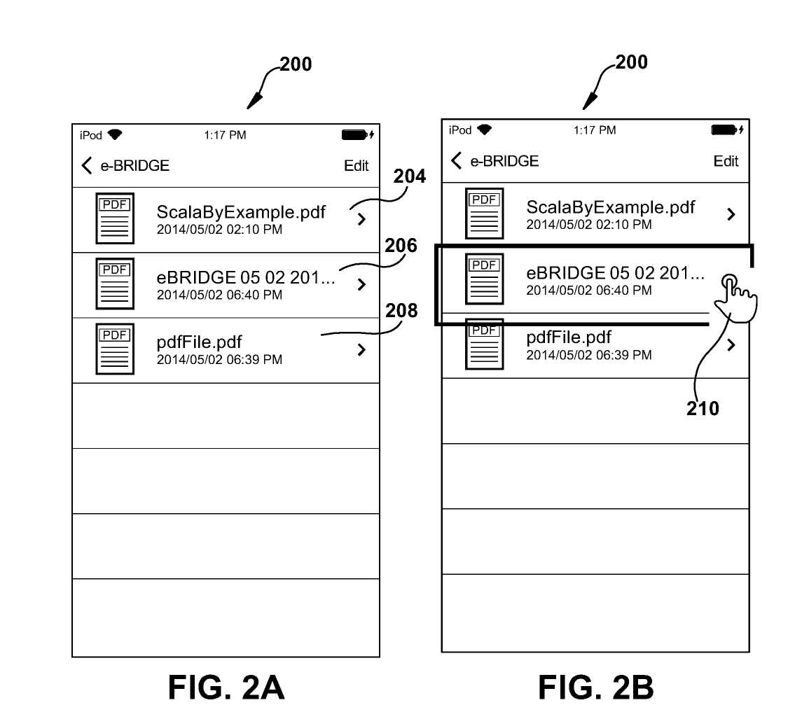

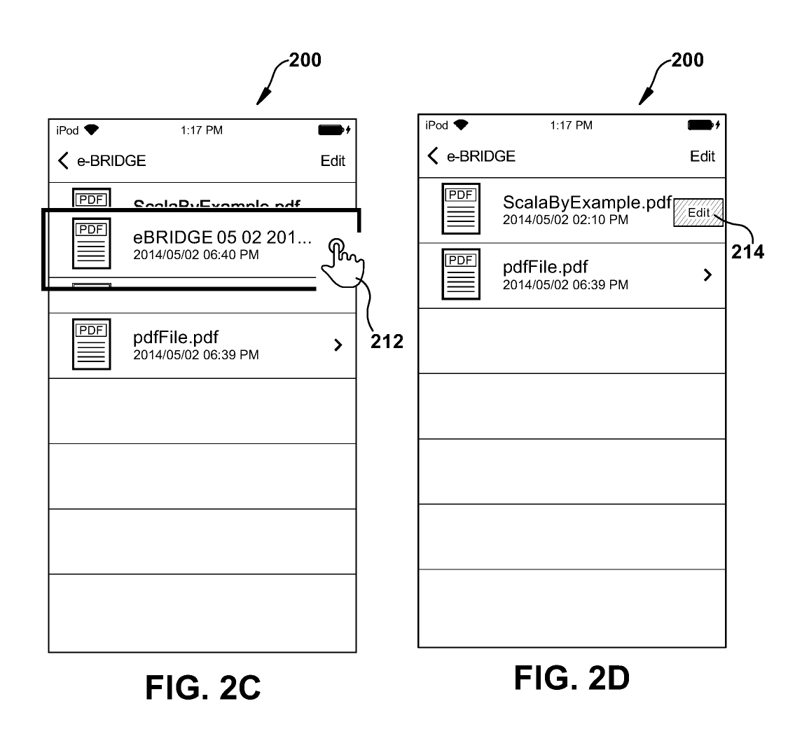

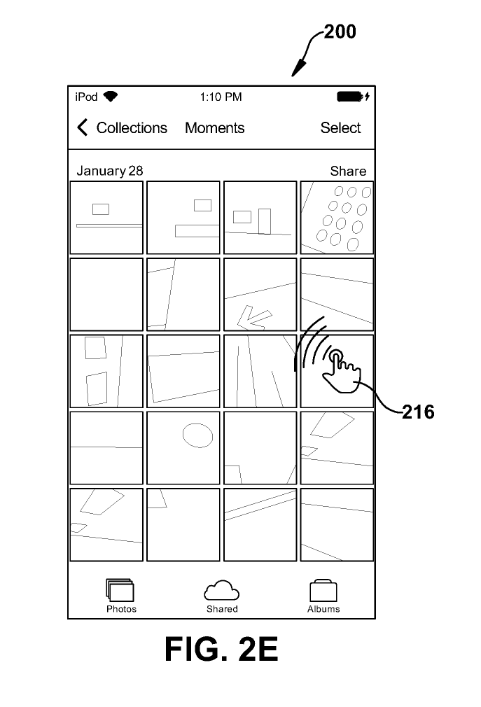

In the illustrated gesture-based document composition system 100, one or more user computing devices are in data communication with network 110, suitably comprised of a local area network (LAN), or wide area network (WAN), alone or in combination and which may further comprise the Internet. In the illustrated example, user computing devices may include devices with wireless or wired data connection to the network 110 and may include devices such as mobile computing device 102. The user computing devices include a user interface that allows a user to input graphical data, such as with gestures including writing or sketching with a finger, stylus, mouse, trackball or the like. By way of further example, user computing devices suitably include a touchscreen that allows a user to input any graphical or handwritten depiction by use of one or more fingers or a stylus. The generated display area is receptive to gesture input, and displays one or more user documents, such as a first document 104 located in a cloud service provider 122, a second document 106 located in a shared network drive 124, and a third document 108 stored locally on the mobile computing device 102. Example operations performed with user gestures on the mobile computing device 102 are illustrated in greater detail in FIGS. 2A-2E.

Turning now to FIG. 2A, illustrated is a first example operation of the gesture-based document composition system 200. The user of the mobile computing device 202 launches or executes an application that lists available user documents such as a first document 204 accessible from a cloud service provider, a second document 206 accessible from a network drive, and a third document 208 stored locally on the mobile computing device 202.

Turning now to FIG. 2B, illustrated is a second example operation of the gesture-based document composition system 200. The user selects 210 one of the available user documents, such as the second document 206 as shown. The user can select 210 the user document using a touch gesture such as a press, a long press, a pressure sensitive press, a radio button selection, or any other suitable gesture. In a configuration the user can select one or multiple user documents.

Turning now to FIG. 2C, illustrated is a third example operation of the gesture-based document composition system 200. The user drags 212 the selected user document onto another user document, using a second touch gesture. For example the user can drag 212 the selected second document onto the first document as illustrated. The gesture-based document composition system 200 combines the documents, for example by appending the second document into the first document. In a configuration, the gesture-based document composition system 200 can additionally query the user for the desired ordering of the documents in the combined document. In another configuration, the gesture-based document composition system 200 can create a new document for the combined document, and query the user for a new document name.

Turning now to FIG. 2D, illustrated is a fourth example operation of the gesture-based document composition system 200. The gesture-based document composition system 200 displays an edit selection tool 214 associated with the combined document of FIG. 2C. The user can select the edit selection tool 214 to open and edit the ordering of pages.

Turning now to FIG. 2E, illustrated is a fifth example operation of the gesture-based document composition system 200. When the user selects the edit selection tool 214 of FIG. 2D the gesture-based document composition system 200 opens a multipage view of the combined document. The user can select and drag 216 pages of the combined document to reorder pages within the combined document. The user can then save the combined document and perform another operation with the documents.

FIGS. 2A-2E illustrate an example gesture-based document composition system 200 for combining individual documents to create a combined document. The gesture-based document composition system 200 can be configured to use and suitable file or input source. For example, the individual documents can be the same type of documents, for example portable document format documents or PDFs. In another example, the individual documents can be different types of documents, for example pictures stored in TIFF or JPG formats. In this example, a PDF document can be combined with one or more photos from the camera roll of the mobile computing device to generate a new document. In a configuration, the source documents can be converted into the format of the destination document. For example, if a photo from the camera roll is dragged onto a PDF file, the photo can be rendered into a PDF page and the resulting combined file can be a PDF file. In an embodiment, the user can determine the file type of the combined document, for example from a selection box presented to the user. In an embodiment, the documents to be combined can be downloaded to the mobile computing device prior to being combined. In an embodiment, the documents to be combined can be sent to a common destination before combination, for example the destination associated with the destination document. In an embodiment, a folder can be selected by selecting the folder and dragging the folder to a destination. In this embodiment, one or more documents in the folder can be combined into the destination to make the combined document.

In an embodiment, when the combined document is first combined, the gesture-based document composition system 200 creates a linked list to store the order. Each time another document is added to the combined document, or the order is changed, or the combined document is otherwise modified, the linked-list is modified accordingly. In this embodiment, the user then commits to the changes and the gesture-based document composition system 200 traverses the linked list to combine the final combined document in the order of the linked list. In an embodiment the linked list can be named and stored. The gesture-based document composition system can maintain a database of linked lists of combined documents. In this embodiment, a linked list can be selected and previously combined file sets can be recombined. In this embodiment, the linked list can be selected to decompose a combined document back into constituent documents. In a configuration, the original file types can be maintained or restored after decomposition.

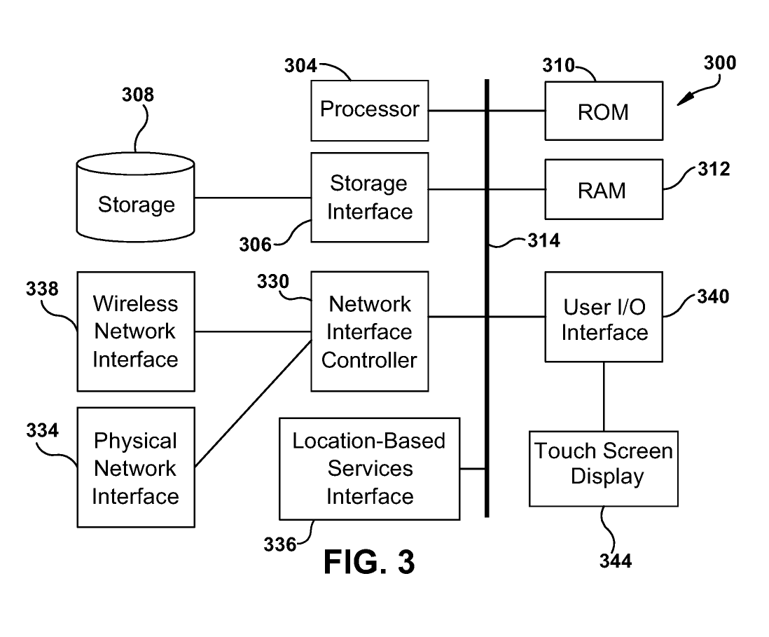

Turning now to FIG. 3, illustrated is an example embodiment of a computing device 300 such as mobile computing device 102, as well as constituents of a cloud-based service provider 122 or shared network drive 124 of FIG. 1. Included are one or more processors, such as that illustrated by processor 304. Each processor is suitably associated with non-volatile memory, such as read only memory (ROM) 310 and random access memory (RAM) 312, via a data bus 314. Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable wired or physical network connection via physical network interface 334, or to any suitable wireless data connection via wireless network interface 338, such as one or more of the networks detailed above. The computing device 300 suitably uses a location based services interface 336 for position data using GPS, network triangulation, or other suitable means. Processor 304 is also in data communication with a user input/output (I/O) interface 340 which provides data communication with user peripherals, such as touchscreen display 344, as well as keyboards, mice, track balls, touch screens, or the like. It will be understood that functional units are suitably comprised of intelligent units, including any suitable hardware or software platform.

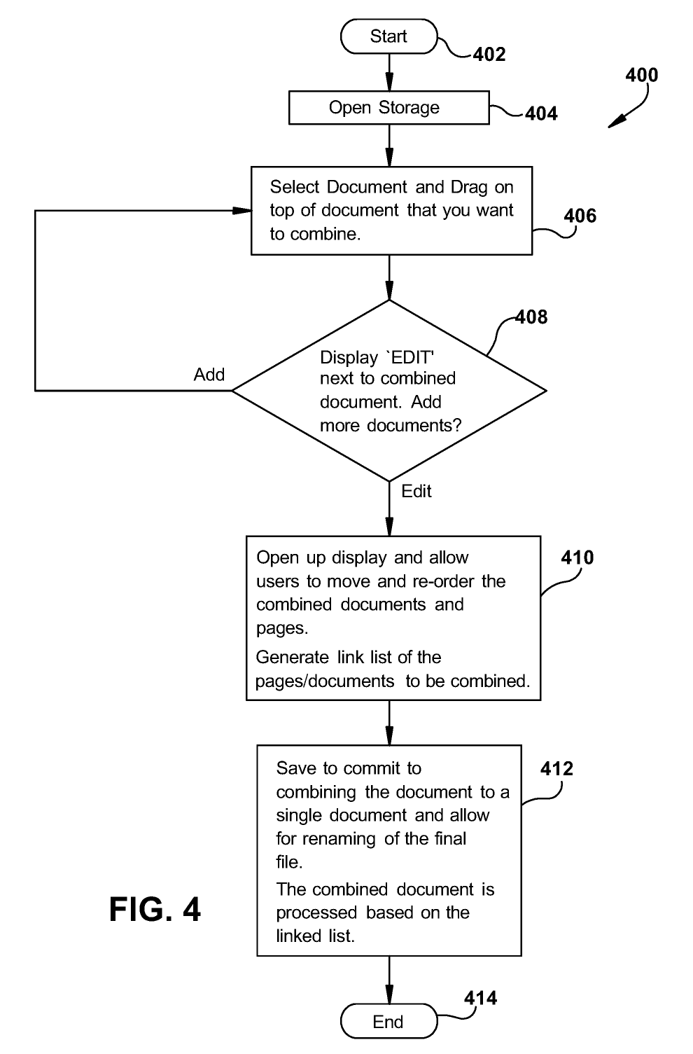

FIG. 4 illustrates a flowchart 400 of example operations of an embodiment of the subject system and method. The process commences at block 402 labeled start, when the gesture-based composition system executes on the mobile computing device. Operation proceeds to block 404.

In block 404, a list of documents is generated and displayed on the touchscreen of the mobile computing device. In a configuration, the user can select input devices for generating the list of documents. For example, the user can select the camera roll or one or more pictures from the cameral roll of the mobile computing devices as documents. In another example, the user can select one or more documents from a shared network drive. In another example the user can select documents from a cloud service provider. In a configuration, the list of documents is generated from a previously saved list of documents previously accessed by the user. In a configuration, the gesture-based document composition system can search for all available document sources available to the user via the mobile computing device. In a configuration, the documents can be sorted, for example using a hierarchical tree structure, such as a tree that uses the source on the first level and subtended folders for any folders in the source. Once the sources are displayed, operation continues to block 406.

In block 406, the user select a document as a source document and using a gesture such as a finger drag on the touchscreen of the mobile computing device the user drags the source document onto a destination document. In an embodiment, the gesture-based document composition system interprets the select and drag gestures and generates a linked list for generating the combined document. Processing continues to decision block 408.

In decision block 408, the gesture-based document composition system displays an “Edit” or similar selection for the combined document, and if the user selects the “Edit” then processing continues to block 410, otherwise processing returns to block 406 to allow the user to add additional documents to the combined document.

In block 410, the gesture-based document composition system displays graphical representations of the pages of the combined document. The user can edit the combined document, for example moving, reordering, or deleting pages in the combined document, for example using gestures such as dragging and dropping via the touchscreen interface of the mobile computing device. In an embodiment, each time the user modifies the combined document, the gesture-based document composition system can update the linked list of documents to be combined into the combined document. Processing continues to block 412.

In block 412, the user can optionally save the combined document to a single combined document. In a configuration, the user can name the new combined document to a different name than the source or destination documents. In a configuration the user can determine where the new document is saved, for example locally on the mobile computing device, or remotely on a network drive or in the cloud. In an embodiment, the gesture-based document composition system processes the linked list and generates the pages of the combined document from the linked list. Processing ends at block 414.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system, comprising:
a touchscreen interface of a mobile computing device configured to
concurrently display a list of documents corresponding to a plurality of electronic documents stored in a plurality of different formats and a plurality of different locations including networked locations, wherein at least one document is stored on a network device and at least one document is stored locally, and
accept a user gesture associated with one or more of the documents;
a processor and associated memory in data communication with the touchscreen interface, the processor configured to
generate the list of documents to be displayed by the touchscreen interface,
interpret the user gesture as a user request to combine a first document from the list with a second document from the list, including a document stored locally and a document stored on the network device,
convert a format of the second document to a format of the first document,
generate a multipage combined document from the first document and second document such that the first document is appended with the second document, and
generate a display of images of pages of the combined document;
wherein the touchscreen interface is further configured to
display the images of the pages of the combined document, and
accept a second user gesture associated with one or more of the pages of the combined document; and
wherein the processor is further configured to
interpret the second user gesture as a second user request to reorder the pages of the combined document, and
generate an updated representation of the pages of the combined document based at least in part on the reordered pages,
wherein the touchscreen interface is further configured to display the updated representation; and
wherein the processor is further configured to generate an updated combined electronic document in a selected document format comprising the combined document based on the reordered pages in the format of the first document.

2. The system of claim 1, wherein the user gesture comprises:
a selection of the first document,
a dragging of the first document over at least a portion of the second document, and
a dropping of the first document onto the second document.

3. The system of claim 1, wherein the processor is further configured to generate, in response to the user request, a linked list based on at least the first document and the second document, and
wherein the operation of generating the updated combined document is based at least in part on the linked list.

4. The system of claim 3, wherein the linked list includes identifying information about the first document and second document, and the order of pages from the first document and second document in the updated combined document.

5. The system of claim 1 wherein the different formats include an image format and a combined text/image format.

6. The system of claim 1, wherein the processor is further configured to generate, in response to the second user request, a linked list that includes the order of the pages of the updated combined document.

7. The system of claim 1, wherein the list of documents to be displayed by the touchscreen interface includes the updated combined document,
wherein the touchscreen interface is further configured to accept a second user gesture associated with a third document and the updated combined document, and
wherein the processor is further configured to
interpret the second user gesture as a second user request to combine the third document with the updated combined document, and
add the third document to the updated combined document.

8. The system of claim 1, wherein the touchscreen interface is further configured to accept a second user gesture associated with the updated combined document, and
wherein the processor is further configured to
interpret the second user gesture as a second user request to output the updated combined document, and
output the updated combined document to a destination selected from the group consisting of the memory of the mobile computing device, a cloud service provider, a network connected device, and a user selected destination.

9. The system of claim 1, wherein each document is selected from the group consisting of a picture stored in a camera roll of the mobile computing device, a document stored in the memory of the mobile computing device, a document stored in a network connected device, and a file stored by a cloud service provider.

10. The system of claim 5 wherein the combined text/image format is comprised of a PDF format.

11. A method comprising:
generating, by a mobile computing device, a list of documents corresponding to electronic documents stored in a plurality of different formats and a plurality of different locations including networked locations;
concurrently displaying a plurality of the list of documents on a touchscreen display of the mobile computing device, wherein at least one document is stored on a networked device and at least one document is stored locally;
receiving, as an input on the touchscreen display, a user gesture associated with at least two of the documents in the list;
interpreting, based on the user gesture receiving, a user request to combine a first document in a first format and a second document in a second format into a combined document;
converting one of the documents into a format of the other;
generating the combined document from the first document and the second document into a common format;
generating images of pages of the combined document,
displaying, on the touchscreen display, the images of pages of the combined document;
accepting, by the touchscreen display, a second user gesture associated with one or more of the pages;
interpreting, based on the second user gesture, a second user request to reorder the pages of the combined document so as to rearrange pages among and between the first and second documents;
generating an updated representation of the pages of the combined document based at least in part on the reordered pages;
displaying, by the touchscreen display, the updated representation;
generating an updated combined electronic document in a selected document format comprising the combined document based on the reordered pages; and
storing the combined electronic document in the common format.

12. The method of claim 11, wherein the user gesture comprises:
a selection of the first document,
a dragging of the first document over at least a portion of the second document, and
a dropping of the first document onto the second document.

13. The method of claim 11, further comprising:
generating, in response to the user request, a linked list based on at least the first document and the second document,
wherein the operation of generating the updated combined document is based at least in part on the linked list.

14. The method of claim 13, wherein the linked list includes identifying information about the first document and second document, and the order of pages from the first document and second document in the updated combined document.

15. The method of claim 14, further comprising:
generating, in response to the second user request, a linked list that includes the order of the pages of the updated combined document.

16. The method of claim 11, further comprising:
displaying a list of documents, by the touchscreen display, that includes the updated combined document;
accepting, by the touchscreen display, a second user gesture associated with a third document and the updated combined document;
interpreting the second user gesture as a second user request to combine the third document with the updated combined document; and
adding the third document to the updated combined document.

17. The method of claim 11 further comprising:
outputting the updated combined document to a destination selected from the group consisting of the memory of the mobile computing device, a cloud service provider, a network connected device, and a user selected destination

18. The method of claim 11, wherein each document is selected from the group consisting of a picture stored in the camera roll of the mobile computing device, a document stored in the memory of the mobile computing device, a document stored in a network connected device, and a file stored by a cloud service provider.

19. A system, comprising:
a network interface configured for data communication with an associated data network, the network interface configured to access one or more network connected storage devices;
a touchscreen configured to display a list of documents that includes a plurality of documents, each document comprised of unique document formats stored on the network connected storage devices, and accept a user gesture to combine at least one of the documents stored on a network connected storage device with another document;
a processor configured to generate the list of documents displayed on the touchscreen, generate a combined document based on the user gesture, the combined document being comprised of a single document format, and output the combined document to at least one of a local memory or one of the network connected storage devices,
wherein the processor is further configured to generate a representation of images of pages of the combined document;
wherein each document in the list of documents is selected from the group consisting of a picture stored in the local memory, a document stored in the local memory, and a network accessible document;
wherein the touchscreen is further configured to
display the content of the pages of the combined document, and
accept a user gesture to reorder the pages of the combined document such that a page associated with one of the plurality of documents is interleaved with pages of another of the plurality of documents;
wherein the processor is further configured to reorder the pages of the combined document based on the user gesture, and
generate an updated combined electronic document in a selected document format comprising the combined document based on the reordered pages.

20. The system of claim 19 wherein at least one document is in an image format and at least one document is in a text format, and wherein the combined document is in a combined text/image format.
